(19) United States
(12) Patent Application Publication
(10) Pub. No.: US 2017/0296937 A1
(43) Pub. Date: Oct. 19, 2017

(54) Folding Kite and Launcher System

(71) Applicant: Tucker International LLC, Hamilton, NJ (US)

(72) Inventors: Simeon E. Tiefel, Siloam Springs, AR (US); Michael J. Goldman, Delran, NJ (US); Thomas J. Gilliano, Audubon, NJ (US); Christopher F. Lauria, Cherry Hill, NJ (US); John M. Lopes, Franklinville, NJ (US)

(73) Assignee: Tucker International LLC

(21) Appl. No.: 15/476,736

(22) Filed: Mar. 31, 2017

Related U.S. Application Data
(60) Provisional application No. 62/324,317, filed on Apr. 18, 2016.
(60) Provisional application No. 62/358,569, filed on Jul. 6, 2016.

(51) Int. Cl. A63H 27/08; A63H 27/00; B64C 31/06

(52) U.S. Cl. CPC A63H 27/08; B64C 31/06; A63H 27/002; A63H 27/007

(57) ABSTRACT

A toy system having a folding kite projectile and a launcher that launches the kite projectile into flight. The kite projectile is launched in a folded configuration. Once in flight, the kite projectile expands into an open configuration. The kite is biased into its open configuration by an internal spring bias. The kite projectile is manually manipulated into its folded configuration prior to launching. The transformation of the kite projectile its folded configuration to its open configuration is delayed by an internal deployment control that opposes the spring bias and delays movement of kite projectile components that expand after launch. In this manner, the kite projectile cn fly in its folded condition for a period before it opens. This maximizes the distance the kite projectile travels by the force of the launcher.

### RELATED APPLICATIONS

This application claims the benefit of U.S. Provisional Patent Application No. 62/324,317, filed Apr. 18, 2016 and U.S. Provisional Patent Application No. 62/358,569, filed Jul. 6, 2016.

### BACKGROUND OF THE INVENTION

1. Field of the Invention

In general, the present invention relates to kites that are launched into the air using a launcher with elastic bands. More particularly, the present invention relates to the structure of both the kite and the launcher used to propel the kite into flight.

2. Prior Art Description

Kites have been in existence for hundreds of years. In that long period of time, kites have been formed into countless shapes and sizes. Traditionally, a kite has a canopy that is held open by two primary supports. It is the canopy that catches the wind and causes the kite to fly. The two primary supports include a spine support and an arm support. The spine support typically extends from the top of the kite to its tail. The arm support crosses the spine support at a perpendicular, wherein the arm support extends from the left side of the kite to the right side in a cross pattern.

Normally, the arm support can be disconnected from the kite. This enables the canopy of the kite to be wrapped around the spine support of the kite when the kite is stored and is not being used.

To make the assembly and disassembly of a kite easier, kite designs have been created with folding arm supports. This enables the arm supports to be selectively extended or collapsed without being disconnected from the canopy and the spine support. This makes the kite collapsible without having to be disassembled. Accordingly, the kite can be rapidly converted from a folded condition to an extended condition with a minimum of effort. Kites with collapsible arm supports are exemplified by U.S. Pat. No. 5,449,135 to Henderson, U.S. Pat. No. 3,749,338 to Kinsey, U.S. Pat. No. 1,690,362 to Witt and U.S. Pat. No. 8,262,027 to Hartasanchez Castillo.

When a kite is made to be collapsible, the arm supports are typically attached to the spine support of the kite at hinge joints. The arm supports rotate about the hinge joints between a folded configuration and an extended configuration. To fold the kite, the arm supports are manually manipulated into their folded configuration. This can be achieved by directly pressing on the arm elements, such as in U.S. Pat. No. 3,749,338 to Kinsey, or by moving a slide along the spine support, like an umbrella. This is shown in U.S. Pat. No. 1,690,362 to Witt. U.S. Pat. No. 8,262,027 to Hartasanchez Castillo discloses a folding kite that is folded by pulling on a cord at the head of the kite.

In the prior art, all the folding kites are designed to fold or unfold when the kite is not in flight. That is, the kites are designed to fold or unfold via manual manipulation when on the ground and in the hands of a user. In the present invention, the kite is combined with a launcher that launches a kite into flight when the kite is in a folded configuration. The kite then automatically unfolds while in flight to catch the wind and begin soaring. The novel construction of the kite and launcher are described and claimed below.

### SUMMARY OF THE INVENTION

The present invention is a toy system having a folding kite projectile and a launcher that launches the kite projectile into flight. The kite projectile is launched in a folded configuration. Once in flight, the kite projectile expands into an open configuration. The kite is biased into its open configuration by an internal spring bias. The kite projectile is manually manipulated into its folded configuration prior to launching. The transformation of the kite projectile its folded configuration to its open configuration is delayed by an internal deployment control that opposes the spring bias and delays movement of kite projectile components that expand after launch. In this manner, the kite projectile cn fly in its folded condition for a period before it opens. This maximizes the distance the kite projectile travels by the force of the launcher.

A tether extends from the launcher to the kite projectile. Once in flight, the kite projectile opens and flies as a kite at the end of the tether.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a perspective view of an exemplary embodiment of a kite and launcher system with a launcher and a kite, wherein the kite is in a fully open configuration;

FIG. 2 is an exploded perspective view of the embodiment of the kite shown in FIG. 1;

FIG. 3 is an enlarged top view of the hub assembly of the kite, shown in a fully open configuration;

FIG. 4 is an enlarged top view of the hub assembly of the kite, shown in a folded configuration;

FIG. 5 is a perspective view of the exemplary embodiment of the kite shown in a folded configuration; and

FIG. 6 is a side view of the kite, in a folded configuration, engaging the launcher.

### DETAILED DESCRIPTION OF THE DRAWINGS

Although the present invention kite and launcher system can be embodied in many ways, the embodiment illustrated shows only one exemplary embodiment of the kite and its launcher. This embodiment is selected in order to set forth one of the best modes contemplated for the invention. The illustrated embodiment, however, is merely exemplary and should not be considered as a limitation when interpreting the scope of the appended claims.

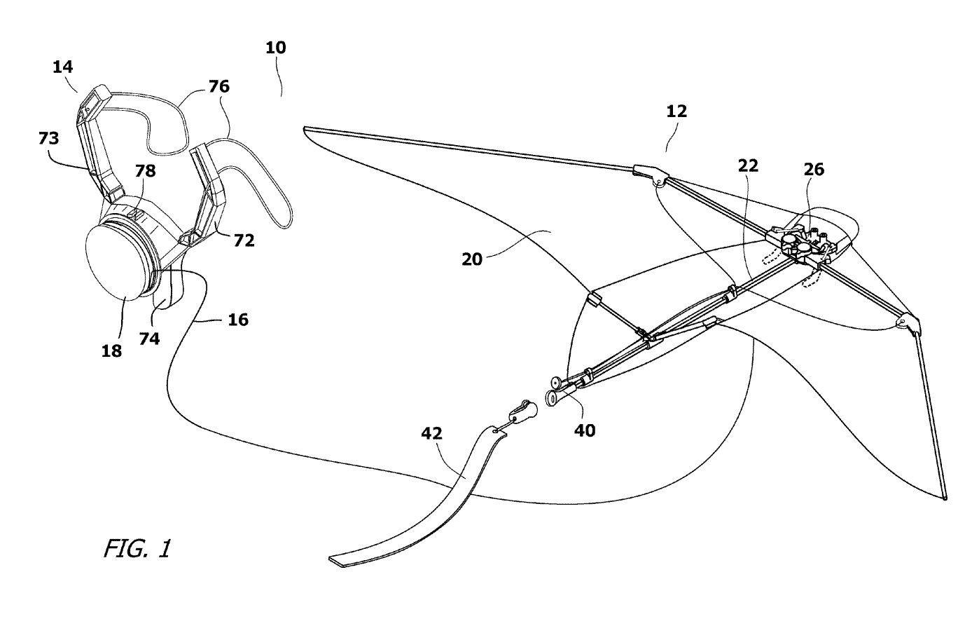

Referring to FIG. 1, a kite and launcher system 10 is shown. The kite launcher system 10 includes both a kite assembly 12 and a launcher assembly 14 for propelling the kite assembly 12 into flight. The launcher assembly 14 also includes a kite string 16 that extends from the launcher assembly 14 to the kite assembly 12. The kite string 16 is wound onto a spool 18 that is part of the launcher assembly 14.

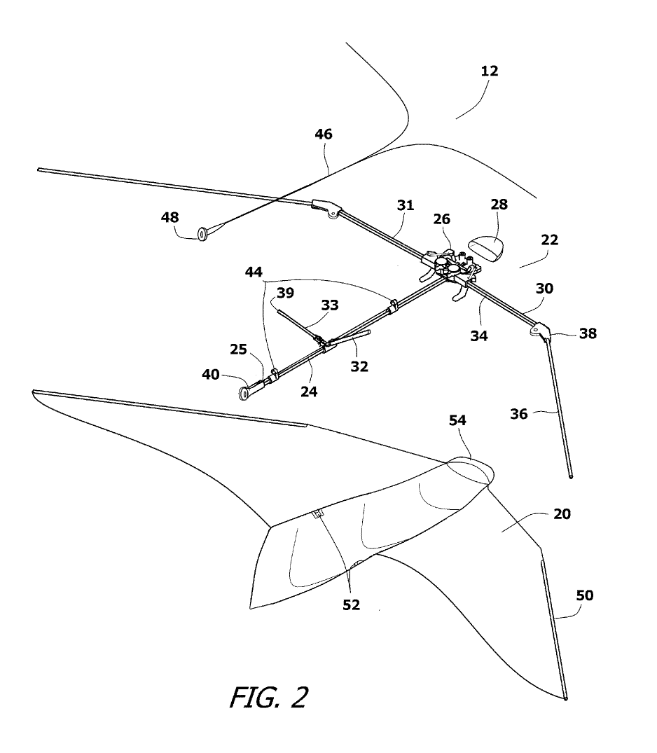

Referring to FIG. 2 in conjunction with FIG. 1, it can be seen that the kite assembly 12 has a canopy 20 that is held open by a support frame 22. The support frame 22 is collapsible and can be configured in either a folded configuration or an open configuration. The open configuration is shown in FIG. 1. The support frame 22 includes a central spine element 24 that is rigid and does not fold. A hub assembly 26 is disposed at one end of the central spine element 24. A soft nose cone 28 covers the hub assembly 26 for safety.

Two sets of spreader arms extend laterally from the central spine element 24. The two sets of spreader arms include a first set of long spreader arms 30, 31 and a second set of short spreader arms 32, 33. The long spreader arms 30, 31 attach to the hub assembly 26 at the first end of the central spine element 24. Each of the long spreader arms 30, 31 have a dogleg configuration wherein a first segment 34 and a second segment 36 meet at an angled elbow connector 38.

The short spreader arms 32, 33 are rigidly affixed to the central spine element 24 of the frame 22 proximate the tail end 25 of the central spine element 24. The short spreader arms 32, 33 symmetrically diverge from the central spine element 24, wherein the short spreader arms 32, 33 terminate at free ends 39.

The tail end 25 of the central spine element 24 terminates with a tail connector 40. The tail connector 40 enables an auxiliary tail 42 to be selectively attached or detached from the kite assembly 12 by the user.

A series of string guides 44 are mounted to the central spine element 24 between the mid-point of the central spine element 24 and its tail end 25. Pull strings 46 are provided. The pull strings 46 are attached to a stop tab 48 that is too large to pass through the string guides 44. The pull strings 46 pass through the string guides 44 along the central spine element 24. After passing through the furthest string guide from the tail end 25, the pull springs 46 diverge in opposite directions. The pull strings 46 extend unguided to the angled elbow connectors 38 on the long spreader arms 30, 31. At the angled elbow connectors 38, the pull strings 46 are tied so that the pull strings 46 are connected to the angled elbow connectors 38.

The support frame 22 supports the canopy 20. The segments 34, 36 of the long spreader arms 30, 31 pass into edge pockets 50 along the forward edges of the canopy 20. The free ends 39 of the short spreader arms 32, 33 engage small pockets 52 on the canopy 20. A large pocket 54 is formed at the head of the canopy 20. The large pocket 54 passes over the nose cone 28 and retains the nose cone 28 over the hub assembly 26.

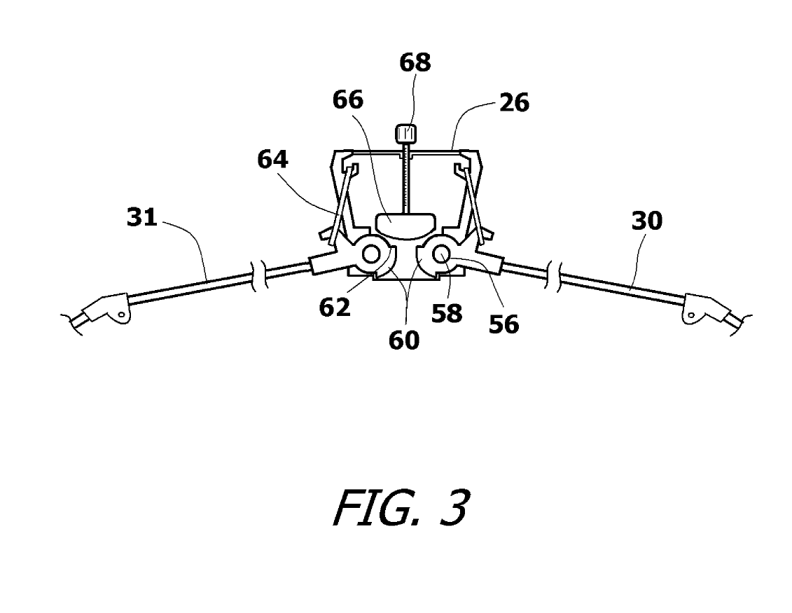

Referring to FIG. 3, it can be seen that the long spreader arms 30, 31 each connect to the hub assembly 26 at a hinge connection 56. More specifically, each of the long spreader arms 30, 31 terminates with an annular cam head 60 that passes around a pivot pin 58 on the hub assembly 26. Each cam head 60 has a circumferential stop 62 that contacts the hub assembly 26 and prevents the over rotation when the long spreader arms 30, 31 are at either their fully open orientations or their fully closed orientations. The long spreader arms 30, 31 are spring biased into their fully open position by elastic bands 64. The elastic bands 64 extend from the hub assembly 26 to the cam head termination 60 of each of the long spreader arms 30, 31.

A friction pad 66 is provided in the hub assembly 26. The friction pad 66 presses against the cam head terminations 60 of the long spreader arms 30, 31. This creates friction against the cam head terminations 60 and controls how fast the long spreader arms 30, 31 rotate under the bias of the elastic bands 64. The position of the friction pad 66 is adjustable using a manual adjustment knob 68. In this manner, a user can control the friction against the friction pad 66 and can control the speed at which the long spreader arms 30, 31 turn about their hinge connections 56.

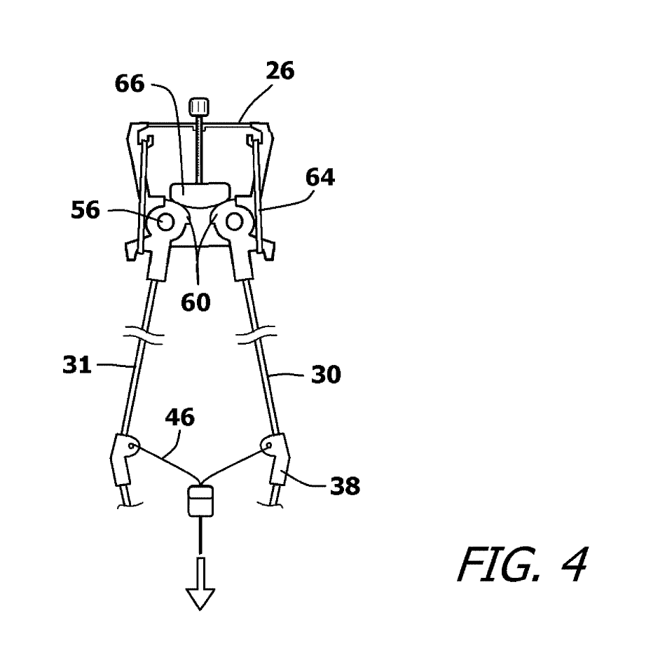

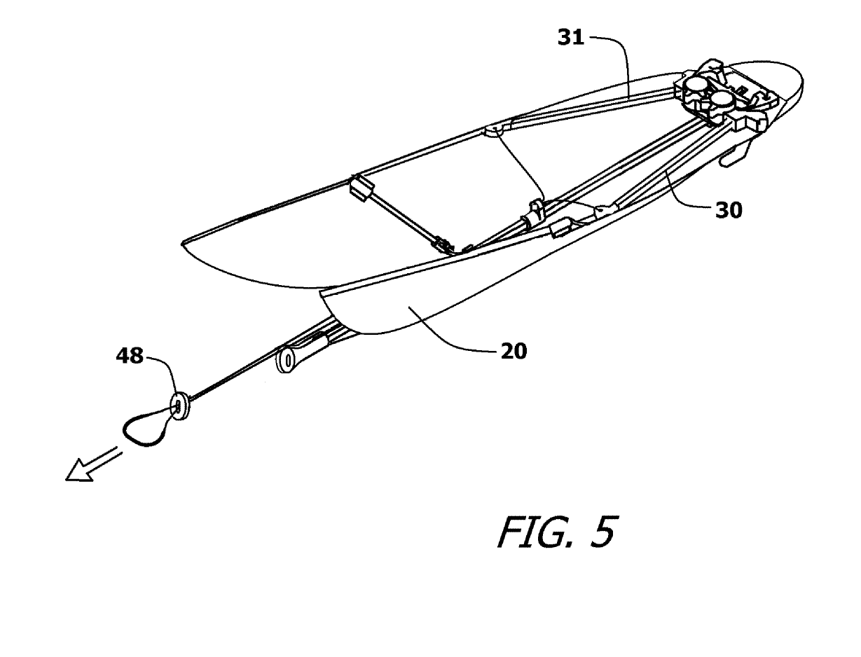

Referring to FIG. 4 and FIG. 5 in conjunction with FIG. 2 and FIG. 3, it will be understood that when a user pulls the stop tab 48 of the pull strings 46, the tension in the pull strings 46 is directed to the angled elbow connectors 38 on the long spreader arms 30, 31. If the tension in the pull strings 46 is sufficient to overcome the counteracting force of the spring bias, then the long spreader arms 30, 31 will begin to rotate at the hinge connections 56 in the hub assembly 26. If the tension is maintained, the long spreader arms 30, 31 will rotate to their fully folded positions, such as is shown in FIG. 5.

When the stop tab 48 and the pull strings 46 are released, the spring bias created by the elastic bands 64 immediately acts to rotate the long spreader arms back to their fully open configuration. The speed at which the long spreader arms 30, 31 rotate from their fully folded configuration (FIG. 4) to their fully extended configuration (FIG. 3) can be controlled by adjusting the position of the friction pad 66 and the friction that the friction pad 66 exerts against the rotating cam head terminations 60 of the long spreader arms 30, 31.

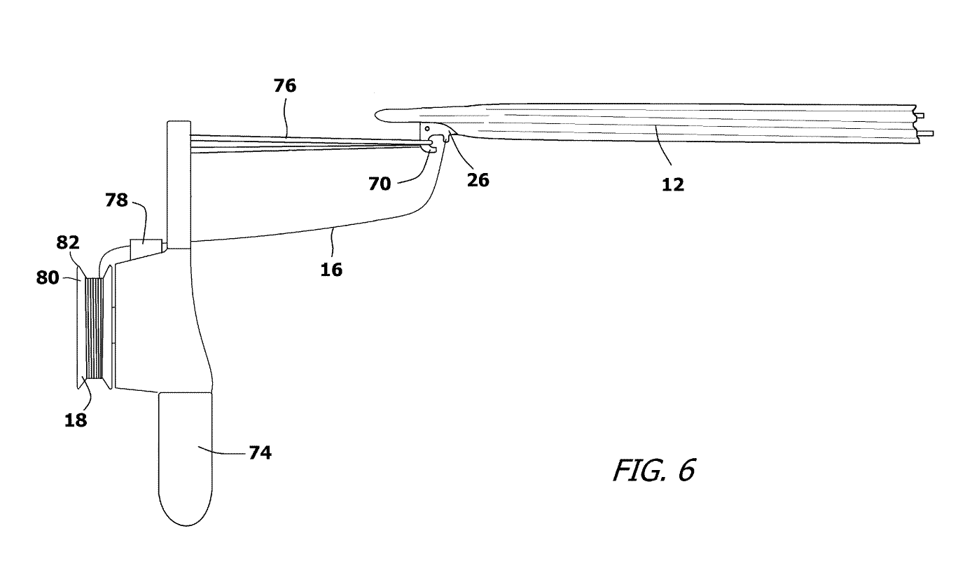

Referring to FIG. 6 in conjunction with FIG. 1, it can be seen that a hook projection 70 extends from the hub assembly 26. When the kite assembly 12 is in its fully folded configuration, the hook projection 70 is unobstructed and readily engages with the launcher assembly 14. The launcher assembly 14 is configured as a sling shot. The launcher assembly 14 has a Y-shaped configuration where two yoke arms 72, 73 extend from a central handle 74. Elastic loops 76 are anchored to the yoke arms 72, 73. The spool 18 is positioned in front of the handle 74. A slotted string guide 78 is provided above the spool 18. When the kite assembly 12 is launched, the kite string 16 is run through the slotted string guide 78 to prevent tangling on the yoke arms 72, 73. When ready to launch, the kite string 16 can freely unwind from the spool 18 with little friction. In this manner, the kite string 16 does not place undue drag on the launching kite assembly 12.

The kite assembly 12 is loaded onto the launcher assembly 14 by engaging the hook projections 70 on the kite assembly 12 with the elastic bands 64 on the launcher assembly 14. Once the elastic bands 64 are engaged by the hook projections, a user pulls on the stop tab 48. This has two effects. First, pulling on the stop tab 48 causes the kite assembly 12 to fold into its folded configuration. Second, pulling on the stop tab 48 causes the elastic bands 64 on the launcher assembly 14 to stretch. Once the elastic bands 64 have been sufficiently stretched, the user releases the stop tab 48. This releases the energy stored in the elastic bands 64 and the kite assembly 12 is launched into flight. Although flying away from the launcher assembly 14, the kite assembly 12 remains tethered to the launcher assembly 14 as the kite string 16 unwinds from the spool 18. Simultaneously, due to its internal spring bias, the kite assembly 12 changes its shape from its folded configuration to its open configuration. The rate of change from the folded configuration to the open configuration can be adjusted by adjusting the position of the friction pad 66 within the hub assembly 26. In this manner, the kite assembly 12 can be adjusted to not fully open until the kite assembly 12 is at the apex of its launch trajectory.

From FIG. 6, it will be understood that as the kite assembly 12 is launched from the launcher assembly 14, the kite string 16 unwinds from the spool 18. The kite string 16 must unwind from the spool 18 in a rapid fashion. To accommodate this need, the spool 18 has a forward flange 80 with a large outer diameter. The forward flange 80 has a preferred diameter of between 2.5 inches and 4.5 inches. Furthermore, at the edge of the flange 80 is smooth and rounded to ensure that the kite sting 16 passes smoothly from the spool 18. The spool 18 is position on the front of the launcher assembly 14 so that the unraveling of the kite string 16 occurs perpendicular to the plane of winding.

It will be understood that the embodiment of the present invention that is illustrated and described is merely exemplary and that a person skilled in the art can make many variations to that embodiment. For example, the elastic bands that provide the spring bias to the kite assembly 12 can be replaced with mechanical springs. Likewise, the shape of the canopy can be changed and the shape of the support frame can be changed to accommodate the shape of the canopy. All such embodiments are intended to be included within the scope of the present invention as defined by the claims.

What is claimed is:

1. A toy system, comprising:
a kite configurable between a folded configuration and an open configuration, wherein said kite has a spring bias that biases said kite into said open configuration;
a launcher for launching said kite in said folded configuration, wherein said spring bias causes said kite to transform from said folded configuration to said open configuration once launched from said launcher; and
a tether that extends from said launcher to said kite.

2. The toy system according to claim 1, further including a spool that is coupled to said launcher, wherein said tether dispenses from spool when said kite is launched by said launcher.

3. The toy system according to claim 1, wherein said launcher includes at least one elastic band that selectively engages said kite and propels said kite into flight by being stretched and released.

4. The toy system according to claim 3, wherein said kite includes a canopy that is supported by a support frame, wherein said support fame contains at least one hook for engaging said at least one elastic band on said launcher.

5. The toy system according to claim 4, wherein said support frame includes a hub and spreader arms that are connected to said hub with hinge connections, wherein said spreader arms interconnect with said canopy, and wherein said spreader arms rotate about said hinge connections when said kite transforms between said folded configuration and said open configuration.

6. The toy system according to claim 5, wherein said support frame further includes a spine support that extends from said hub in a first direction, wherein said spine support terminates at a tail end.

7. The toy system according to claim 6, further including a connector at said tail end for selectively attaching an auxiliary tail to said spine support.

8. The toy system according to claim 6, further including string guides on said spine support and a pull string that extends through said string guides, wherein said pull string attaches to said spreader arms and moves said spreader arms about said hinge connections in opposition to said spring bias when pulled.

9. The toy system according to claim 5, wherein said spring bias is created by spring elements that engage both said spreader arms and said hub.

10. The toy system according to claim 9, wherein said spring elements are elastic bands.

11. The toy system according to claim 5, wherein each of said spreader arms terminates with a head termination that is part of said hinge connections in said hub.

12. The toy system according to claim 11, further including a friction pad that contacts each said head termination and resists rotation of said spreader arms between said folded configuration and said open configuration.

13. The toy system according to claim 12, wherein said friction pad is selectively adjustable within said hub.

14. A toy system, comprising:
a flying projectile having a canopy supported by a support frame, wherein said support frame has spreader arms that are connected to a hub at hinge connections, wherein said spreader arms can be selectively rotated about said hinge connections between a folded configuration and an open configuration;
bias elements that provide a spring bias to said spreader arms that bias said spreader arms into said open configuration;
a deployment control that controls rotational velocity of said spreader arms about said hinge connections from said folded configuration to said open configuration; and
a launcher for launching said flying projectile into flight when in said folded configuration.

15. The toy system according to claim 14, further including a pull string, coupled to said spreader arms that move said spreader arms to said folded configuration when pulled.

16. The toy system according to claim 14, wherein said launcher includes at least one elastic band that selectively engages said flying projectile and propels said flying projectile into flight by being stretched and released.

17. The toy system according to claim 16, wherein said support frame contains at least one hook for engaging said at least one elastic band on said launcher.

18. The toy system according to claim 14, wherein each of said spreader arms terminates with a head termination that is part of said hinge connections in said hub.

19. The toy system according to claim 18, wherein said deployment control includes a friction pad that contacts each said head termination and resists rotation of said spreader arms between said folded configuration and said open configuration.

20. The toy system according to claim 19, wherein said friction pad is selectively adjustable within said hub to adjust said movement speed.
